(19) United States
(12) Patent Application Publication
(10) Pub. No.: US 2014/0144182 A1
(43) Pub. Date: May 29, 2014

(54) APPARATUS AND METHOD FOR SHAPING A GLASS SUBSTRATE

(71) Applicants: Thierry Luc Alain Dannoux, Avon (FR); Allan Mark Fredholm, Vulaines sur Seine (FR)

(72) Inventors: Thierry Luc Alain Dannoux, Avon (FR); Allan Mark Fredholm, Vulaines sur Seine (FR)

(21) Appl. No.: 13/818,871

(22) PCT Filed: Aug. 30, 2011
(86) PCT No.: PCT/US11/49625

§ 371 Date: May 9, 2013

Related U.S. Application Data
(60) Provisional application No. 61/378,114, filed on Aug. 30, 2010.

(51) Int. Cl. C03B 23/03; C03B 23/035

(52) U.S. Cl. CPC C03B 23/0307; C03B 23/0357
USPC 65/103; 65/273; 65/243

(57) ABSTRACT

An apparatus and method for shaping a substantially planar glass substrate are disclosed. The glass substrate is supported on a shaping body having a substantially planar central portion and arcuate edge portions. The substrate is heated by a suitable radiant heat source wherein a thermal shield is used to shield a centrally located surface of the glass substrate so that only edge portions of the glass substrate are heated and softened. Gravity causes the glass substrate edge portions to sag and conform to the shape of the shaping body. In some embodiments, shaping members are pressed against the glass substrate edge portions to aid in the conforming. In certain other embodiments, a plurality of glass substrates are sequentially deformed by a shaping die.

### CLAIMING BENEFIT OF PRIOR FILED U.S. APPLICATION

This application claims the benefit of U.S. Provisional Application Ser. No. 61/378,114, filed on Aug. 30, 2010. The content of this document and the entire disclosure of publications, patents, and patent documents mentioned herein are incorporated by reference.

### FIELD

This invention relates to a method and apparatus for shaping a glass substrate, and more particularly to a method and apparatus for forming curved surfaces in edge portions of the glass substrate.

### BACKGROUND

In the past, the shaping of individual sheets of glass has been done largely through heating and pressing, or heating or slumping. That is, an individual sheet of glass is heated to an appropriate forming temperature, then pressed to obtain the final shape. Alternatively, the sheet is placed in a mold, heated, and allowed to conform to the desired shape via gravity (slumping). Such methods have been restricted to large radius bends that affect the entire sheet, and are widely deployed in the formation of automobile windshield glass.

Recent trends in the display industry point to increasingly thinner devices. One such example is light emitting diode backlighting for televisions that allow for a dramatically thinner device compared to earlier cold cathode fluorescent lighting. Additional steps are being undertaken to significantly reduce, or eliminate, the frame or external bezel around the display to provide a simple, cleaner appearance to the overall product. One method of producing a product of this type is to include a faceplate or cover glass that wraps around the product front and in particular the edge area of the product.

### SUMMARY

In accordance with one embodiment, a method for shaping a glass substrate is disclosed comprising positioning a substantially planar glass substrate between a shaping body and a thermal shield, the shaping body having a contact surface in contact with the glass substrate and wherein the shaping body contact surface comprises a planar central portion and arcuate edge portions; heating the substantially planar glass substrate wherein, during the heating, the thermal shield shields a central portion of the substantially planar glass substrate, but exposes edge portions of the substantially glass substrate so that only the edge portions soften from the heating; and wherein the heating causes the edge portions to deform and contact the shaping body edge portions while the central portion of the substrate remains substantially planar.

The thermal shield may, in some examples, contact the substantially planar glass sheet during the heating.

The method may further comprise pressing forming members against the edge portions of the substantially planar glass substrate to conform the glass substrate edge portions to the shaping body edge portions. A vacuum may be applied to the glass substrate edge portions through passes disposed within the shaping body to draw and hold the glass substrate edge portions against the shaping body edge portions.

Certain methods may include developing relative motion between a shaping die and a stacked assembly comprising a plurality of substantially planar glass substrates and a plurality of shaping bodies, such that edge portions of the plurality of glass substrates are sequentially deformed and pressed against arcuate edge portions of the plurality of shaping bodies by an arcuate contact surface of the shaping die. In other embodiments, the contact surface of the shaping die may flat, and oriented such that is at an angle relative to a vertical plane.

In still another embodiment, an apparatus for shaping a glass substrate is described comprising a shaping body including a first surface, wherein the shaping body first surface includes a planar central portion and arcuate edge portions; a thermal shield disposed between a heat source and the shaping body such that a portion of a glass substrate supported by the shaping body first surface is shielded from thermal radiation emitted by the heat source. The shaping body may include passages in communication with a vacuum source so that a vacuum can be applied to the edge portions of the glass substrate.

The shaping apparatus may further comprise shaping members configured to press edge portions of the glass substrate against the arcuate edge portions of the shaping body. the shaping members include an arcuate surface generally complimentary to the shape of the arcuate edge portions of the shaping body the apparatus may comprise a plurality of shaping bodies for supporting a plurality of glass substrates positioned between the shaping bodies, and a shaping die comprising an arcuate contact surface that sequentially contacts and deforms edge portions of the plurality of glass substrates when relative motion is developed between the shaping die and the plurality of shaping bodies. The shaping die can include a heating element used to heat the edge portions of the plurality of glass substrates.

Additional features and advantages of the invention are set forth in the detailed description which follows, and in part will be readily apparent to those skilled in the art from that description or recognized by practicing the invention as described herein. The accompanying drawings are included to provide a further understanding of the invention, and are incorporated in and constitute a part of this specification. It is to be understood that the various features of the invention disclosed in this specification and in the drawings can be used in any and all combinations.

### BRIEF DESCRIPTION OF THE DRAWINGS

FIG. 1 is a cross sectional edge view of a portion of a device, such as a television display, shown viewing the device from the top downward, and with a wrap-around faceplate depicted partially pulled away.

FIG. 2 is a cross sectional view of an apparatus for shaping a glass substrate, and in particular, forming arcuate edges on the glass substrate, wherein a thermal shield does not contact the glass substrate.

FIG. 3 is a cross sectional view of another apparatus for shaping a glass substrate, wherein a thermal shield contacts the glass substrate.

FIG. 4 is a cross sectional view of yet another embodiment of an apparatus for shaping a glass substrate, wherein forming members are used to press edge portions of a glass substrate against a shaping body.

FIG. 5 is still another embodiment of an apparatus for shaping a glass substrate, wherein vacuum passages in a forming body are used to assist shaping members that press edge portions of the glass substrate into contact with the forming body.

FIG. 6A-6B are cross sectional views showing the progressive operation of shaping dies having arcuate shaping surfaces are applied against edge portions of a plurality of glass substrates arranged in a stack with a plurality of shaping bodies and a thermal shield.

FIG. 7 is a cross sectional side view of an embodiment of an apparatus for shaping a glass substrate, similar to the apparatus of FIGS. 6A-6B, except that the shaping surfaces of the shaping dies that contact the plurality of glass substrates are angled relative to a vertical plane.

### DETAILED DESCRIPTION

In the following detailed description, for purposes of explanation and not limitation, example embodiments disclosing specific details are set forth to provide a thorough understanding of the present invention. However, it will be apparent to one having ordinary skill in the art, having had the benefit of the present disclosure, that the present invention may be practiced in other embodiments that depart from the specific details disclosed herein. Moreover, descriptions of well-known devices, methods and materials may be omitted so as not to obscure the description of the present invention. Finally, wherever applicable, like reference numerals refer to like elements.

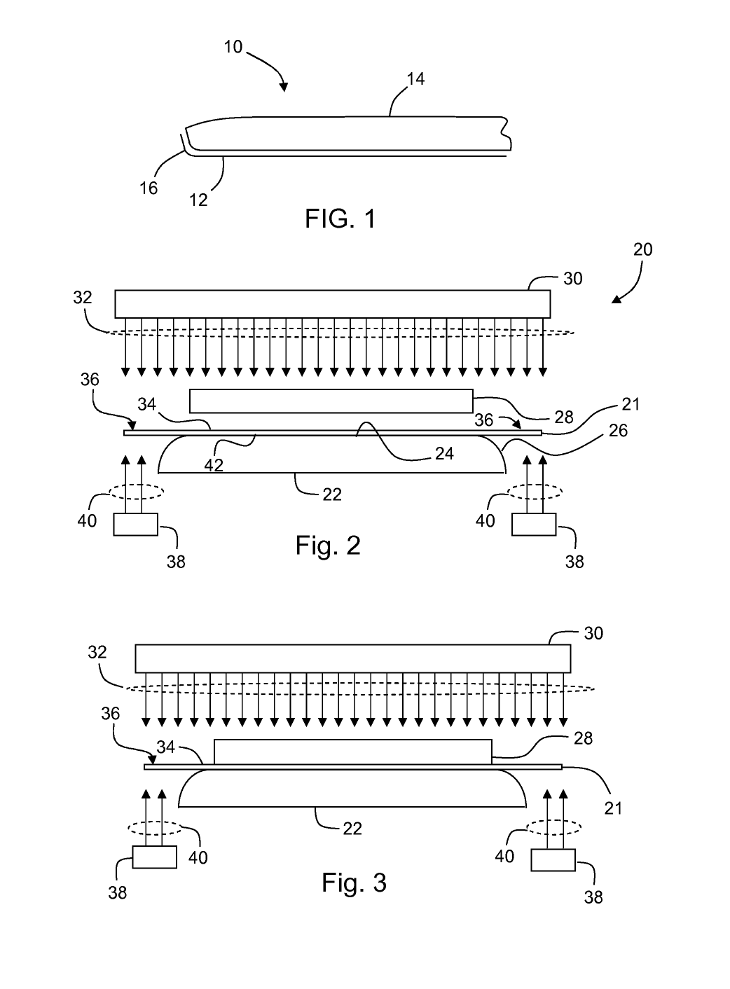

Shown in FIG. 1 is an edge portion of a display product 10, such as a television or computer monitor, illustrating the placement of a wrap-around cover glass 12 that will be fitted to the front (viewer side) of a display device 14. The edge portion of the product is seen in cross section, as one looks down on the device. By wrap-around what is meant is that a curved edge portion 16 of the cover glass deviates from the plane of the majority of the glass cover plate surface. When placed over an appropriate display product, curved edge portion 16 of the cover glass wraps or folds around at least a portion of the thickness of the display device. The end result is a smooth, aesthetically pleasing display front. The manufacture of such cover glass sheets is the subject of the following disclosure.

FIG. 2 depicts an apparatus 20 for shaping an initially substantially planar glass substrate 21 according to a first embodiment. As used herein, a substantially planar glass substrate is a sheet of glass comprising two major parallel surfaces, a thickness between the two parallel surfaces preferably being less than 1 mm, and wherein a gravity-free deviation from planar is no more than about 500 μm. Gravity-free is intended to mean the shape of the glass substrate in the absence of gravity, which would otherwise distort or bend the shape of the substrate. Apparatus 20 comprises a mold or shaping body 22 having an upper surface 24 that is substantially planar over a major area of its surface, but with arcuate edge portions 26. Apparatus 20 further includes thermal shield 28 disposed between shaping body 22 and a heat source, such as a radiant heat source 30. Radiant heat source may be any suitable heat source capable of radiating sufficient heat to soften substantially planar glass substrate 21. For example, the radiant heat source may be an infrared heat source, such as one or more infrared lamps, or the heat source may include electrical resistance heating elements. The radiant heat source directs heat energy, represented collectively by arrows 32, in a direction toward a first surface 34 of substantially planar glass substrate 21 supported by shaping body 22. Radiant heat energy 32 is blocked from irradiating an interior surface portion of glass substrate 21 shielded by thermal shield 28. That is, a major area of the first surface of the glass substrate inward of edge portions 36 of the glass substrate is facing the heat source. However, thermal shield 28 is sized such that radiant heat energy 32 emitted by heat source 30 impinges only on edge portions 36 of glass substrate 21 that extend beyond thermal shield 28. Additional radiant heat sources 38 may be used to direct radiant heat energy 40 in a direction toward second surface 42 of substantially planar glass substrate 21 opposite and parallel to first surface 34. The heating of edge portions 36 by a sufficient amount of radiant heat energy 32, and optionally radiant heat energy 40, results in a decrease in viscosity of the edge portions, and a deformation of the edge portions. To wit, edge portions 36 of the substantially planar glass substrate are softened by the heating from the impinging radiant energy and deformed by gravity such that they conform to the arcuate shape of the shaping body edge portions 26. Consequently, a glass substrate is formed having substantially planar interior surfaces (inward of the edge portions) and arcuate edge portions 36. The effect of thermal shield 28 is to limit any increase in temperature of the interior surface portions of the glass substrate below a temperature at which deformation of the interior surface portions can occur. In other words, the glass substrate is selectively heated such that the interior surface portions remains elastic in nature. Thus, the interior surface portions of glass substrate 21 do not undergo plastic deformation, and the surface finish remains as originally provided into the shaping process.

In some embodiments, thermal shield 28 may be positioned over substantially planar glass substrate 21 such that the thermal shield does not contact the glass substrate during the shaping process, as shown in FIG. 2. In other embodiments, depicted in FIG. 3, thermal shield 28 is placed in contact with substantially planar glass sheet 21 (i.e. first substrate surface 34). It should be noted, however, that in neither case does thermal shield 28 extend over the edge portions 36 of substantially planar glass substrate 21.

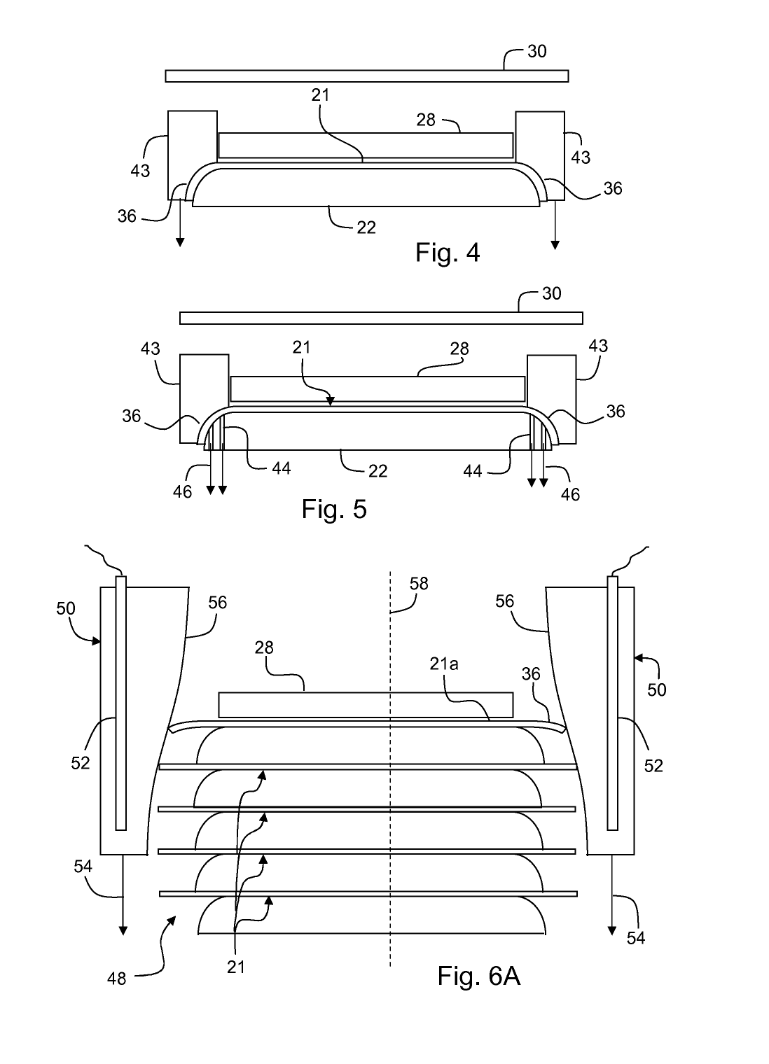

In still another embodiment shown in FIG. 4, once the irradiating and heating of substantially planar glass substrate 21 are undertaken, shaping members 43 are pressed into contact with the softened edge portions 36 of the substantially planar glass substrate to conform the edge portions of the glass substrate to the edge portions of shaping body 22. In some embodiments, illustrated in FIG. 5, passages 44 within the shaping body are used to convey a vacuum from a suitable vacuum source to second surface 42 at edge portions 36 as represented by arrows 46. The vacuum aids in drawing edge portions 36 into contact with the shaping body.

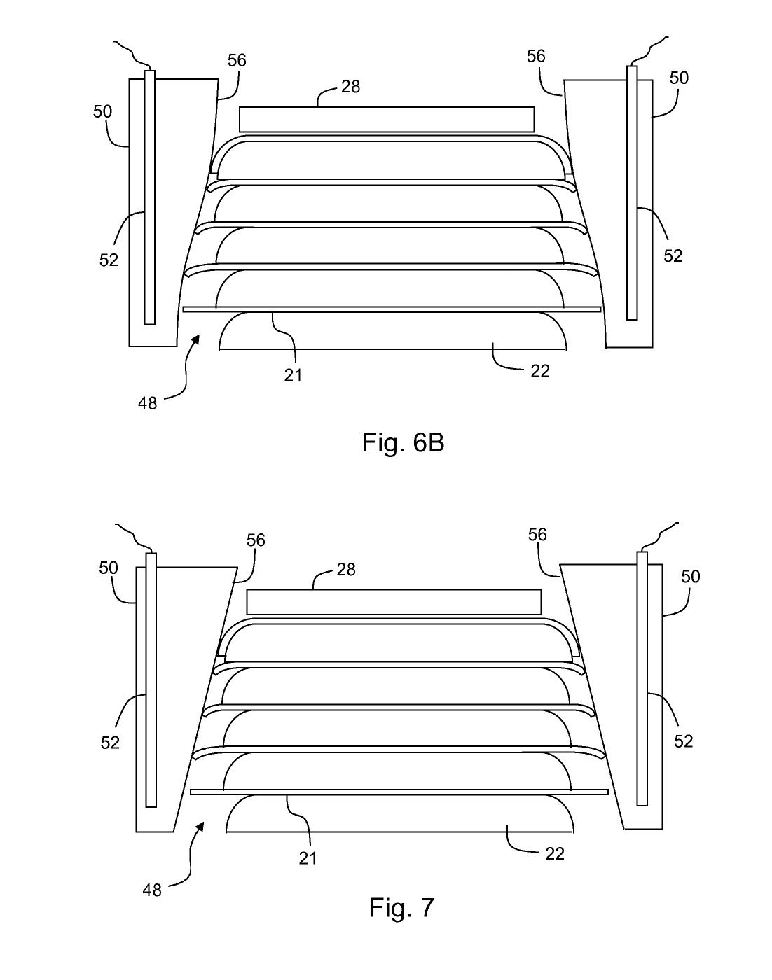

In yet another embodiment, illustrated in FIGS. 6A-6B, a plurality of shaping bodies 22 and substantially planar glass substrates 21 are stacked in an alternating vertical arrangement to form stacked assembly 48. A thermal shield 28 is positioned over the top-most substantially planar glass substrate in the stacked assembly. The radiant heating element 30 has been omitted from FIGS. 6A, 6b and 7 for clarity of the other components of the apparatus. As in the preceding embodiments, thermal shield 28 that shields the glass substrates from radiant heat energy emitted by heat source 30 may be contacting or non-contacting with the top-most substantially planar glass substrate. A shaping die 50 is positioned above and outside a perimeter of the stacked assembly. The shaping die may constitute a single die, or a plurality of dies as illustrated in FIGS. 6A-6B. Shaping die 50 may include one or more heating elements 52 that heat the shaping die. For example, shaping die 50 may include one or more resistance heating element disposed within the shaping die. Relative motion is developed between the shaping die or dies and the stacked assembly of shaping bodies and glass substrates, represented by arrows 54. For example, the shaping die may be moved relative to stacked assembly 48, or the stacked assembly moved relative to the shaping die, or both the shaping die and the stacked assembly are moved relative to each other. The movement can be effected by any suitable moving apparatus, including but not limited to hydraulic or pneumatic jacks, or electric or hydraulic motors and appropriate gearing. The shaping die includes a contact surface 56 facing in a direction toward stacked assembly 48 as the shaping die moves into a position laterally adjacent to the stacked assembly. The contact surface of the shaping die is arranged such that a distance between a perimeter of each glass substrate and the contact surface of the shaping die decreases as the stacked assembly and/or shaping die is moved. Accordingly, a first glass sheet 21a that contacts the shaping die is gradually deformed by contact surface 56, the magnitude of the deformation increasing as the relative movement between the shaping die and glass substrate perimeter progresses. The effect is such that as the relative motion progresses, the edge portions 36 of each glass substrate are sequentially deformed an increasing amount until the edge portions of the glass substrates are in contact with and conform to a shape of the shaping bodies 22, i.e. a substantially planar interior surface portion and one or more arcuate edges. Contact surface 56 may be an arcuate surface, or it can be a planar surface that is oriented at a non-zero angle relative to a vertical plane (e.g. plane 58, seen edge-on in FIG. 6A).

It should be apparent to one skilled in the art given the benefit of the present disclosure that the surface of the shaping die that contacts the edge portion of the glass substrates need not be arcuate, but could instead be an angled planar contact surface 56 as shown in FIG. 7.

It should be emphasized that the above-described embodiments of the present invention, particularly any “preferred” embodiments, are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

1. A method for shaping a glass substrate comprising:
positioning a substantially planar glass substrate between a shaping body and a thermal shield, the shaping body having a contact surface in contact with the glass substrate and wherein the shaping body contact surface comprises a planar central portion and an arcuate edge portions;
heating the substantially planar glass substrate with a heat source positioned above the thermal shield wherein, during the heating, the thermal shield shields a central portion of the substantially planar glass substrate from thermal radiation emitted by the heat source, but exposes edge portions of the substantially planar glass substrate to the thermal radiation so that only edge portions of the glass substrate soften from the heating; and
wherein the heating causes the edge portions of the glass substrate to deform and contact the shaping body edge portions while the central portion of the substrate remains substantially planar.

2. The method according to claim 1, wherein the thermal shield contacts the substantially planar glass sheet during the heating.

3. The method according to claim 1, further comprising pressing a shaping members against an edge portions of the substantially planar glass substrate to conform the glass substrate edge portions to the shaping body edge portions.

4. The method according to claim 1, further comprising applying a vacuum to the glass substrate edge portions to draw the glass substrate edge portions against the shaping body edge portions.

5. The method according to claim 3, further comprising developing relative motion between a shaping member and a stacked assembly comprising a plurality of substantially planar glass substrates and a plurality of shaping bodies, such that edge portions of the plurality of glass substrates are sequentially deformed and pressed against arcuate edge portions of the plurality of shaping bodies by the shaping member.

6. An apparatus for shaping a glass substrate comprising:
a heat source;
a shaping body including a first surface, wherein the first surface includes a planar central portion and an arcuate edge portions; and
a thermal shield positioned between the heat source and the shaping body first surface such that a portion of a glass substrate supported by the shaping body first surface is shielded from thermal radiation emitted by the heat. source.

7. The apparatus according to claim 6, wherein the shaping body comprises passages in communication with a vacuum source.

8. The apparatus according to claim 6, further comprising a shaping members configured to press an edge portions of the glass substrate against the arcuate edge portions of the shaping body.

9. The apparatus according to claim 6, further comprising a plurality of shaping bodies for supporting a plurality of glass substrates positioned between the shaping bodies, and a shaping member comprising a contact surface configured such that the contact surface sequentially contacts and deforms edge portions of the plurality of glass substrates when relative motion is developed between the shaping member and the plurality of shaping bodies.

10. The apparatus according to claim 9, wherein the shaping member comprises a heating element.

11. The apparatus according to claim 9, wherein the contact surface is an arcuate surface.

12. The apparatus according to claim 9, wherein the contact surface is a planar surface.

13. The apparatus according to claim 12, wherein the planar contact surface is oriented at a non-zero angle relative to a vertical plane.

14. The method according to claim 3, wherein the shaping member comprises a arcuate surface that contacts the edge portion of the glass substrate during the pressing.

15. The method according to claim 5, wherein the shaping member comprises a arcuate surface that contacts the edge portions of the plurality of glass substrates during the pressing.

16. The method according to claim 5, wherein the shaping member comprises a heating element that heats the edge portions of the glass substrates during the pressing.
